(19) United States
(12) Patent Application Publication
(10) Pub. No.: US 2013/0192875 A1
(43) Pub. Date: Aug. 1, 2013

(54) Body Coil for Magnetic-Resonance Imaging

(71) Applicant: Daniel Driemel, Oederan (DE)

(72) Inventor: Daniel Driemel, Oederan (DE)

(21) Appl. No.: 13/756,165

(22) Filed: Jan. 31, 2013

(30) Foreign Application Priority Data
Feb. 1, 2012 (DE) DE 102012201453.5

(51) Int. Cl. H02G 15/007

(52) U.S. Cl. CPC H02G 15/007
USPC 174/135

(57) ABSTRACT

A body coil for magnetic-resonance imaging includes at least one coil component. A movable lead terminated by a plug is provided on the at least one coil component. A retaining element having an oblong opening, through which the movable lead or a plug section is passed and within which the movable lead or the plug section is movable longitudinally, is provided on the at least one coil component.

This application claims the benefit of DE 10 2012 201 453.5, filed on Feb. 1, 2012, which is hereby incorporated by reference.

### BACKGROUND

The present embodiments relate to a body coil.

Body coils are employed, for example, within the scope of magnetic-resonance imaging and are matched in shape to measuring specific regions of the body. Thus, for example, head coils that have an open, head-encompassing shape and spine coils that have an elongated shape, on which the patient lies are known. The body coil may include a single part, but in the case of a head coil, a plurality of parts may be included. What the body coils have in common is that the body coils include a coil component, on which a movable lead terminated by a plug is provided. The body coil is connected via the plug to a signal terminal that is provided on a patient-table side and via which measurement signals registered on the coil side are tapped. Owing to the high contact density and special requirements to be met, for example, within the framework of magnetic-resonance imaging, the plug may be very heavy. The plug swings around in a manner dependent on the length of the lead while the body coil or coil component is being handled and so may move freely. The body coil or coil component may be handled prior to actual measuring because, for example, in the case of a head coil, a top part of the body coil or the coil component may not be emplaced until the patient has been positioned. Because of the length of the supply lead, the plug is able to move. The plug swings around, and while the body coil or coil component is being handled, the plug may very easily strike against the patient table or coil carriage, on which the body coil is initially situated. The plug housing may be damaged, and contact pins may be bent through the striking action. The result of the damage is that the body coil is no longer usable and will have to be repaired.

While it is known how to provide a form-fit plug holder on the body coil or coil component (e.g., to form in the coil housing a recess that matches the shape of the plug and into which the plug may be inserted when not needed and held in position there lightly clamped), not every type of body coil offers sufficient space to form a form-fit plug holder of such kind. The user is to deliberately and actively insert the plug into the plug holder. Failure to do so provides that the plug will swing around as before and may be damaged.

### SUMMARY AND DESCRIPTION

The present embodiments may obviate one or more of the drawbacks or limitations in the related art. For example, a body coil that avoids undesired swinging of a plug is provided.

A retaining element having an oblong opening, through which a lead or a plug section is passed and within which the lead or plug section may be moved longitudinally, is provided on a coil component for a body coil.

The body coil includes a clamp-like retaining element having an opening (e.g., an oblong opening), through which the lead extends or a section of the plug engages if the plug is oblong in shape. The lead or plug section may be moved lengthwise within the opening, which provides that while a degree of movement is possible, the lead or plug section is perforce restricted because the opening in the retaining element is delimited. Thus, there is a certain basic movement capability allowing the plug to be inserted and removed once the body coil or coil component has been put into position. The lead or plug is restricted in movements to the extent that being able to move only inside the opening, the lead or plug may not swing around freely. This provides that there will be sufficient movement for connecting and disconnecting the plug without the plug needing to be taken out of the retaining element. The retaining element restricts movement so that an undesired swinging motion and hence striking action is prevented. Since the lead or plug section is kept in the retaining element at all times, the basic movement capability or restriction thereof applies so that the action of swinging freely is prevented in handling situations. The user will consequently not be required to deliberately position the plug before or after the measuring operation in order to fix the plug in place.

According to one embodiment, the retaining element may have a narrowing that divides the opening into a longer first region and a shorter second region, with the lead or plug section being movable across the narrowing from one region into the other. The opening is consequently subdivided into two regions via the slight narrowing. In the first, longer region, the plug section or lead may be moved a sufficient way lengthwise for the plug to be put into the plugging position or disconnected by being unplugged. In the second region, which is shorter and into which the plug section or lead may be put by moving the plug across the narrowing, the plug may, if required, be fixed sufficiently securely into position. The first, longer region will be close to the table when the body coil or coil component is in the mounted position, with the socket, into which the plug is to be fitted, being, for example, on an upper side of the table. The plug is to be moved downward within the oblong first region and plugged into position. The shorter, second region is located above the first region as a direct extension thereof. If the plug is then pulled (e.g., disconnected), the plug will be automatically moved along the first region. Continuing in that direction of motion, the plug may be ducted through the narrowing and into the shorter, second region that defines, for example, a parking position. The plug will snap into the second region after passing through the elastic or flexible narrowing. The plug may be accommodated in the second region such as to be capable of minimal movement. In one embodiment, the plug may be fixed into position in the second region. Thus no movement is provided, as the lead or plug section is held in position there lightly clamped so that what is provided is a true parking position (e.g., immobile).

The cross-sectional geometry of the second region may correspond substantially to the cross-sectional geometry of the lead or plug section so that at least partial form-fit fixing or clamping is provided.

The retaining element is sufficiently flexible or elastic in the region of the narrowing. Because the retaining element is made, for example, from a plastic material, the flexibility or elasticity of the retaining element may be defined by designing the wall thickness of the retaining element appropriately. The possibility also exists of embodying the retaining part as a 2-part component and providing a soft plastic component in the region of the narrowing while the rest of the retaining element is made from a harder plastic material.

The retaining element may be closed in the shape of a ring, though has an elongated slot, through which the lead or plug section may be inserted and removed with the flexible retaining element being at the same time bent open slightly. Within the framework of mounting, the retaining element may put the plug section or lead into the retaining element and also remove the plug when required. For this purpose, the retaining element may be bent open slightly so that the elongated slot will open out sufficiently widely. To prevent undesired opening while the body coil is being handled or while the plug is being moved, the retaining element may include a locking element that is to be released for the elongated slot to be opened out. The locking element may be, for example, a slider that may be moved between a locking and unlocking position, a clip, a clamp, or any number of other locking elements.

The retaining element may be secured to the coil component in a manner allowing the retaining element to be detached via a latching connection so the retaining element may easily be fixed into position and also be detached when required. Latching elements that snap into a suitable latch receptacle on the coil component are provided for this purpose on the retaining element. The latching connection may be rigid, providing that the retaining element is immobile in the latched position. In one embodiment, the latching connection is such that the retaining element is rotatably fixed. This enables the change occurring in the position or angle of the lead or plug section when the plug is moved to be compensated.

The retaining element is made, for example, from plastic (e.g., POM or PP). The plastic may be a plastic that is non-critical (e.g., when used within the framework of magnetic-resonance imaging).

### BRIEF DESCRIPTION OF THE DRAWINGS

FIG. 1 is a perspective view of one embodiment of a retaining element;

FIG. 2 is a perspective view of one embodiment of the retaining element shown in FIG. 1;

FIG. 3 shows one embodiment of a body coil having the retaining element secured to the body coil with a plug in a connecting position;

FIG. 4 is an enlarged view of a region where one embodiment of the retaining element is secured to the coil component;

FIG. 5 is the view corresponding to FIG. 3 with the plug in the parking position;

FIG. 6 shows one embodiment of a body coil having a rerouted lead with the plug in the connecting position; and

FIG. 7 shows one embodiment of the body coil shown in FIG. 6 with the plug in the parking position.

### DETAILED DESCRIPTION OF THE DRAWINGS

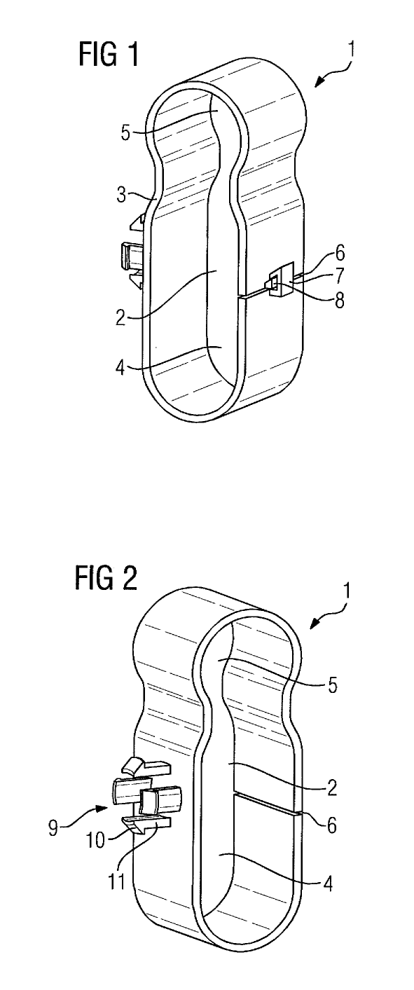

FIG. 1 shows one embodiment of a retaining element 1 made, for example, from plastic (e.g., POM or PP), as a simple injection-molded component. The retaining element 1 is clamp-like, closed in the shape of a ring, and has an opening 2 (e.g., an oblong opening) defined by the basic oblong shape of retaining element 1. The opening 2 is subdivided into two regions 4 and 5 (e.g., a first region 4 and a second region 5) via a narrowing 3. The region 4 is oblong in shape and significantly larger than the second region 5. A plug or lead ducted in the region 4 is capable of moving longitudinally. This is discussed further below. The lead or plug section accommodated in the opening 2 may be ducted across the narrowing 3, which is to take place under the application of slight or adequate pressure so that the narrowing 3 may be bent open, and the lead or plug section may snap into the second region 5 (e.g., the upper region). The upper region 5, in terms of geometry, is matched to the roundish cross-section of the lead or plug section. The lead or plug section is fixed into position in the upper region, which defines a parking position (e.g., in a form-fit manner and so under a slight clamping force so as ultimately to be immobile when snapped into position).

As shown in FIG. 1, the retaining element 1 has an elongated slot 6 enabling the retaining element 1 to be bent open in order, within the framework of mounting, to put the plug section or lead into the opening 2 or remove the plug section or lead therefrom. To prevent the lead or plug section, which may be kept permanently in the retaining element 1, from accidentally slipping out of opening 2 as a result of undesired opening of the elongated slot 6, a locking element 7 (e.g., a slider 8) that is located on the retaining element 1 is provided and may be moved between an unlocking and a locking position. The retaining element 1 may be bent open in the unlocking position while this bending is precluded in the locking position. Other locking elements such as, for example, clips, clamps, or any other locking element may also be provided.

FIG. 2 shows the opposite side of retaining element 1 with a view of laterally provided and molded-on latching elements 9 that serve to effect a latching connection for securing the retaining element 1 to the body coil or coil component. Four such latching elements in the form of pegs 11 furnished with detents 10 are provided in the example shown, with the embodiment being such that what results overall is a round, circular geometry enabling a rotational motion. This provides that the retaining element 1 may, when plugged into position, be rotated around the axis of the latching connection.

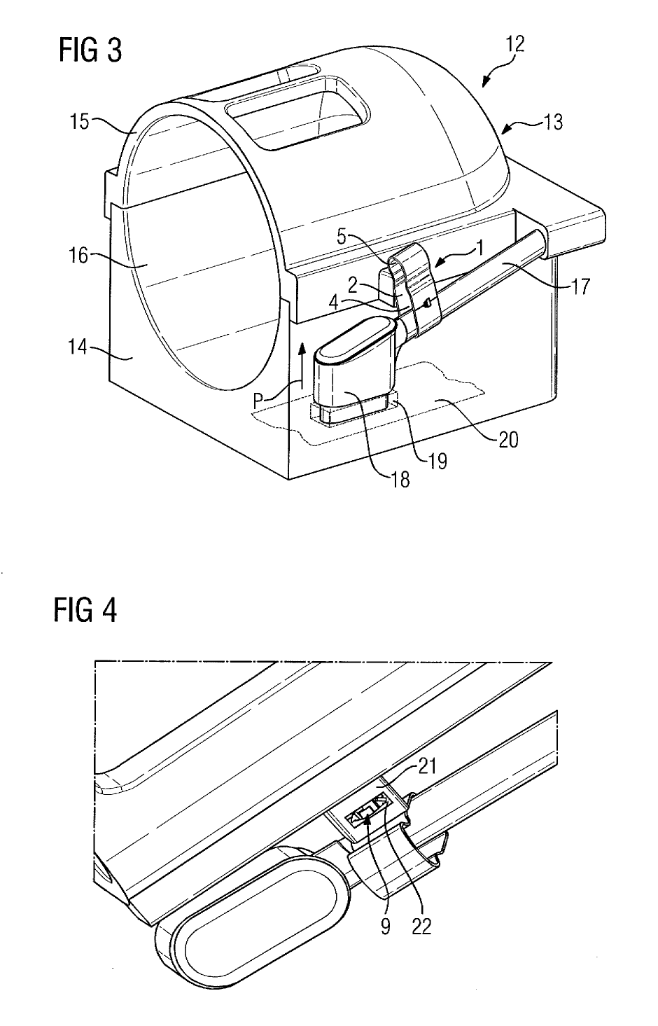

FIG. 3 shows one embodiment of a body coil 12 in the form of, for example, a head coil 13 including a lower coil component 14 and an upper coil component 15. When assembled, the head coil 13 defines a cavity 16, in which the head of the patient being examined is accommodated.

To be able to read out the signals of the coils integrated in the two coil components 14, 15, a lead 17 is terminated by a plug 18 that, in the operating position, is connected to a plug socket 19 (in FIG. 3, only basically indicated) located on an upper side of a patient table 20 (in FIG. 3, only indicated).

The retaining part 1 is secured to the top coil component 15, to which end (see FIG. 4) latching elements 9 have been pushed through a latching opening 22 that is provided on a latching section 21 and behind which the latching elements 9 latch into position. The opening 22 is round so that the latching connection may be rotated. As FIGS. 3 and 4 show, the lead 17 extends through the opening 2. The lead 17 is located in a lower, oblong, second region 4 when the plug 18 is in the connecting position shown in FIG. 3.

If the body coil 12 is to be removed on completion of measuring, the plug 18 is first to be unplugged. The plug 18 is pulled in a direction of arrow P out of the connection to the plug socket 19. The pulling direction also extends along the longitudinal direction of the opening 2 of the retaining element 1. While being pulled and hence moved along the pulling direction P, the plug 18 and thus also the lead 17 accommodated in the opening 2 will be moved along the oblong first region 4 toward the narrowing 3. As movement continues, the narrowing 3 will be bent open so that the lead 17 will, when the pulling motion ends, automatically snap into the upper, smaller second region 5 where the lead 17 will be fixed into position in, for example, a form-fit manner and under a slight clamping force. The clamping force is sufficiently great for the lead 17 to be fixed firmly in place notwithstanding the considerable weight of plug 18. This provides that the plug 18 or the lead 17 will automatically be put into the second region 5 and hence into the parking position when the plug connection is released. Firm and secure fixing is provided in the parking position so that unintended swinging of the plug 18 is precluded.

FIG. 3 shows that the retaining element 1 may twist or swivel slightly around an axis of rotation of the latching connection while the plug 18 or the lead 17 is being moved from the plugging position shown in FIG. 3 into the parking position shown in FIG. 5. The changed angular position of the plug 18 or the lead 17 is compensated by a slight rotational movement executed by the retaining element 1.

The plug 18 and hence also the lead 17 are moved in the reverse direction when the plug 18 is moved out of the parking position shown in FIG. 5 into the plugging position shown in FIG. 3. The plug 18 is to be pushed down for that purpose so that the plug 18 is moved out of the clamped fixing in the upper opening region 5 across the narrowing 3. The plug 18 is movable within the lower oblong opening region 4 until the plug is in the plugging position. The plugging position may be correlated with a bottom end of the opening 2 or the opening region 4. The opening may also be somewhat longer to give some extra space.

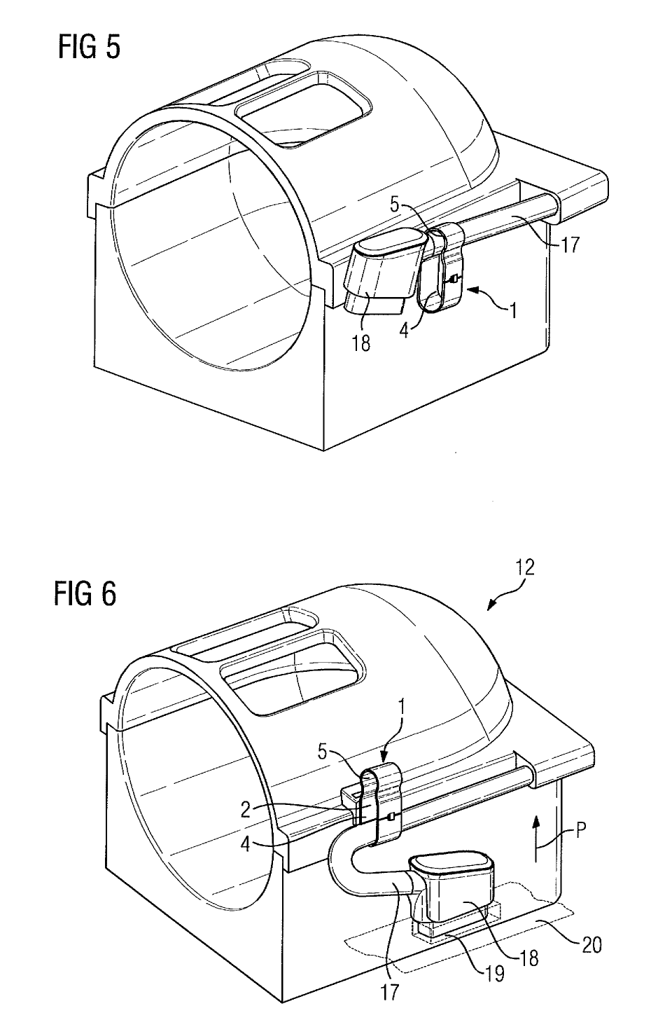

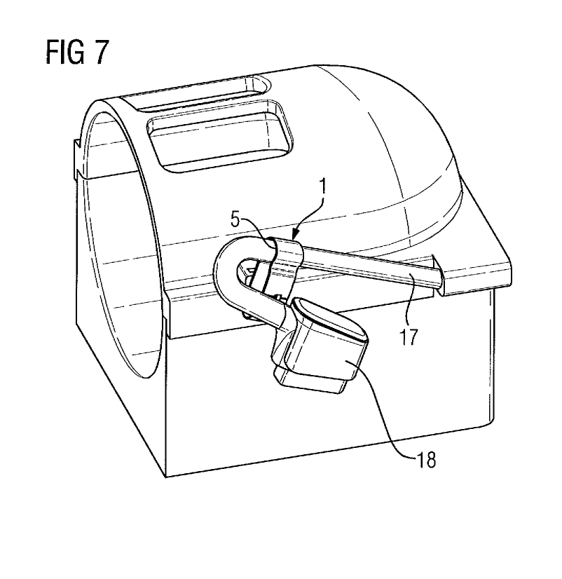

FIGS. 6 and 7 show an embodiment of a body coil 12 (e.g., a head coil) that, to an extent, corresponds to the embodiments according to FIGS. 3 and 5 except that the lead 17 is ducted somewhat differently. The lead 17 is rerouted so that the plug 18 is arranged turned through 180° and has, in the plugging position shown in FIG. 6, been plugged into the plug socket 19 on the patient table 20. As in the case of the previously described embodiment, the lead 17 is also accommodated in the opening 2 of the retaining element 1 despite the fixed rerouting (e.g., the rerouted section is rigid, providing that the plug 18 may not swing out of the rerouted position). The functioning mode is the same as that described with reference to FIGS. 3 and 5. When the plug 18 is released from the position shown in FIG. 6, the plug 18 is again moved upward in the direction of arrow P, with the lead 17 being simultaneously taken upward and moving into the opening 2. That motion continues until the lead 17 snaps across the narrowing 3 into the upper region 5 and is fixed into position there in, for example, a clamped manner. The plug 18 will then be in the parking position shown in FIG. 7.

The slight twisting of the retaining element l that occurs when the plug 18 is moved is also shown in FIGS. 6 and 7.

The plug 18 and thus also the lead 17 are also moved in the reverse direction for plugging in. The plug 18 is pushed down from the parking position shown in FIG. 7 so that, owing to the pressure, the lead 17 snaps out of the clamped parking position in the upper opening region 5 and moves across the narrowing 3 into the lower region 4. The plug 18 is thereupon put into the plugging position, as shown in FIG. 6.

Although illustrated and described in more detail using the exemplary embodiments, the invention is not limited by the examples disclosed, and a person skilled in the relevant art may derive other variations therefrom without departing from the protective scope of the invention.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A body coil for magnetic-resonance imaging, the body coil comprising:
at least one coil component, on which a movable lead terminated by a plug is provided; and
a retaining element disposed on the at least one coil component, the retaining element comprising an oblong opening, through which the movable lead or a plug section is passed and within which the movable lead or the plug section is movable longitudinally.

2. The body coil as claimed in claim 1, wherein the body coil is a head coil.

3. The body coil as claimed in claim 1, wherein the retaining element comprises a narrowing that divides the oblong opening into a longer first region and a shorter second region, the movable lead or the plug section being movable across the narrowing from one region of the longer first region and the shorter second region into the other region of the longer first region and the shorter second region.

4. The body coil as claimed in claim 3, wherein the movable lead or the plug section is securable in the longer first region such that the lead is movable longitudinally, and
wherein the movable lead or the plug section is securable in the shorter second region such that the movable lead is fixed into position.

5. The body coil as claimed in claim 4, wherein a cross-sectional geometry of the shorter second region corresponds to a cross-sectional geometry of the movable lead or the plug section requiring to be secured into position in the shorter second region.

6. The body coil as claimed in claim 3, wherein the retaining element is elastic in a region of the narrowing.

7. The body coil as claimed in claim 1, wherein the retaining element is closed in the shape of a ring and further comprises an elongated slot, through which the movable lead or the plug section is insertable or removable, the retaining element being flexible and bent open slightly.

8. The body coil as claimed in claim 7, further comprising a locking element that has to be released for opening the elongated slot, the locking element being provided on the retaining element.

9. The body coil as claimed in claim 1, wherein the retaining element is detachably secured to the at least one coil component via a latching connection.

10. The body coil as claimed in claim 9, wherein the latching connection is configured such that the retaining element is rotatably fixed.

11. The body coil as claimed in claim 1, wherein the retaining element is made from plastic.

12. The body coil as claimed in claim 11, wherein the plastic is polyoxymethylene (POM) or polypropylene (PP).

13. The body coil as claimed in claim 5, wherein the retaining element is elastic in a region of the narrowing.

14. The body coil as claimed in claim 5, wherein the retaining element is closed in the shape of a ring and further comprises an elongated slot, through which the movable lead or the plug section is insertable or removable, the retaining element being flexible and bent open slightly.

15. The body coil as claimed in claim 6, wherein the retaining element is closed in the shape of a ring and further comprises an elongated slot, through which the movable lead or the plug section is insertable or removable, the retaining element being flexible and bent open slightly.

16. The body coil as claimed in claim 5, wherein the retaining element is detachably secured to the at least one coil component via a latching connection.

17. The body coil as claimed in claim 8, wherein the retaining element is detachably secured to the at least one coil component via a latching connection.

18. The body coil as claimed in claim 17, wherein the latching connection is configured such that the retaining element is rotatably fixed.

19. The body coil as claimed in claim 5, wherein the retaining element is made from plastic.

20. The body coil as claimed in claim 10, wherein the retaining element is made from plastic.
